(19) United States
(12) Patent Application Publication
(10) Pub. No.: US 2014/0180447 A1
(43) Pub. Date: Jun. 26, 2014

(54) SMART ADAPTER AND REMOTE CONTROL SYSTEM USING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,338

(22) Filed: Aug. 29, 2013

(30) Foreign Application Priority Data
Dec. 26, 2012 (CN) 2012105731502

(51) Int. Cl. G05B 15/02

(52) U.S. Cl. CPC G05B 15/02
USPC 700/90

(57) ABSTRACT

A remote control system includes a remote control device in the hands of a user, a smart gateway, and a smart adapters and a number of home devices. The smart gateway is connected to each home device via the smart adapter and power lines. The remote control device communicates with the smart gateway, and sends control information for controlling a target home device with a UID code to the smart gateway. The smart gateway receives and converts the control information into a control command, then transmits the control command to the smart adapter. The smart adapter modulates the control command and converts between network protocols as required, to generate an effective control signal, then transmits the control signal to the target home device to control the target home device to execute a required function.

### BACKGROUND

1. Technical Field

The present disclosure relates to remote control technology, and particularly to a smart adapter capable of functioning by remote control and a remote control system using the smart adapter.

2. Description of Related Art

Adapters are connected between a commercial power source and an electronic device. The adapter obtains electrical power from the power source, and adapts or converts the power to a proper and stable direct current (DC) power supply, to power the electronic device. However, that function of the adapter is the sole function, and user needs to manually connect to or disconnect the adapter from the electronic device or the power source, to control the electrical connection between the electronic device and the power source, which is inconvenient for user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a smart home network system, according to a first embodiment.

FIG. 2 is a block diagram of a smart gateway and a smart adapter of the system of FIG. 1.

FIG. 3 is a block diagram of a home device of the system of FIG. 1.

FIG. 4 is a block diagram of a register controller of the system of FIG. 1.

FIG. 5 is a schematic diagram of a mapping list stored in the smart gateway of FIG. 2.

FIG. 6 is a schematic diagram of a control interface displayed on the smart gateway of FIG. 2 or on a remote control device.

FIG. 7 is another schematic diagram of a control interface displayed on the smart gateway of FIG. 2 or on a remote control device.

FIG. 8 is a flowchart illustrating a method for registering a number of home devices with a smart gateway, according to a second embodiment.

FIG. 9 is a flowchart illustrating a method for registering a number of home devices with a smart gateway, according to a third embodiment.

FIG. 10 is another schematic diagram of a mapping list stored in the smart gateway of FIG. 2.

FIG. 11 is a flowchart illustrating a method for registering a number of home devices with a smart gateway, according to a fourth embodiment.

### DETAILED DESCRIPTION

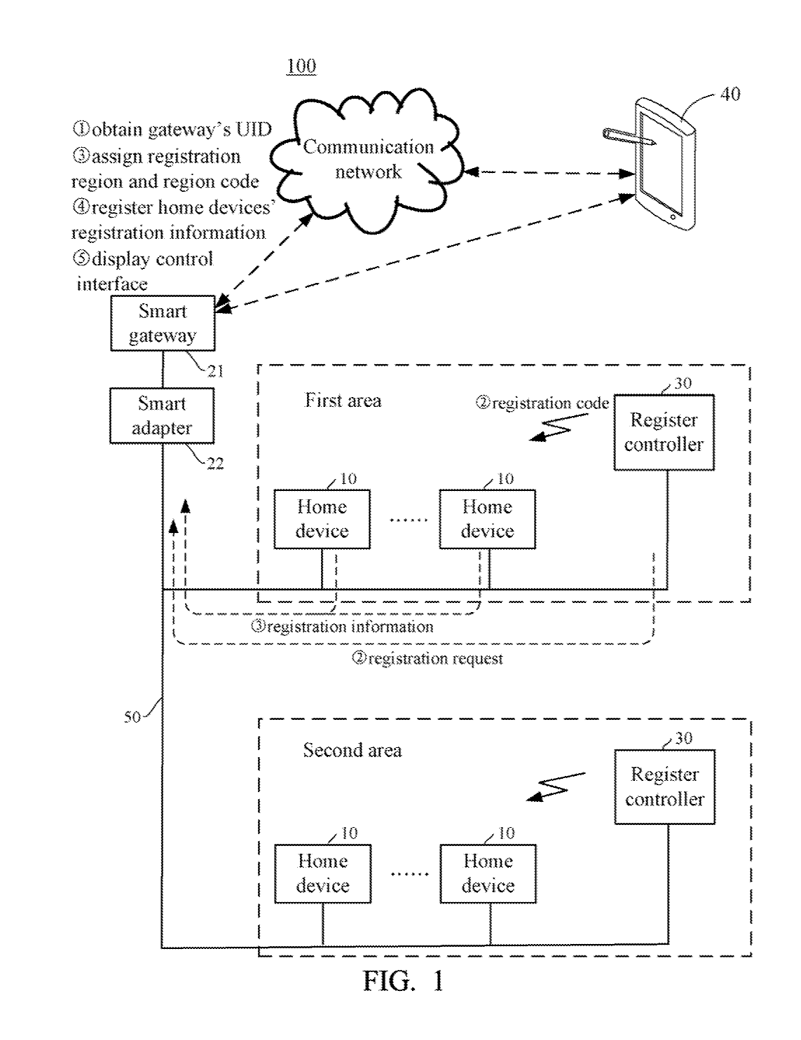

FIG. 1 shows a smart home network system 100. The system 100 includes a number of home devices 10, a smart gateway 21, a smart adapter 22, and a remote control device 40. The home devices 10 may include, but are not limited to being, a fridge, an air conditioner, a fan, a computer, a TV, an audio player, an electric rice cooker, a microwave oven, a water heater, a lamp, an electric curtain, and a smart socket. The remote control device 40 may be selected from a group consisting of a smart phone, tablet computer, and other remote control device.

In this embodiment, the smart gateway 21 is connected to the home devices 10 via the smart adapter 22 and power lines 50. The smart adapter 22 communicates with each home device 10 via PLC (Power Line Communication) technology or OPLC (Optical Fiber Power Line Communication) technology. In another embodiment, the smart adapter 22 can communicate with each home device 10 via Internet communication, coaxial cable communication, telephone line communication, or other communication technologies.

The smart gateway 21 is also connected to a communication network, and communicates with the remote control device 40 via wired or wireless communication technologies. In use, the remote control device 40 communicates with the smart gateway 21 and sends control information for controlling a target home device 10 to the smart gateway 21. The smart gateway 21 receives the control information from the remote control device 40, and transmits the control information to the target home device 10 via the smart adapter 22 and the power lines 50, to control the target home device 10 to execute a required function.

In this embodiment, each device in the system 100 is provided with a unique identification (UID) code so that it can be identified by other devices.

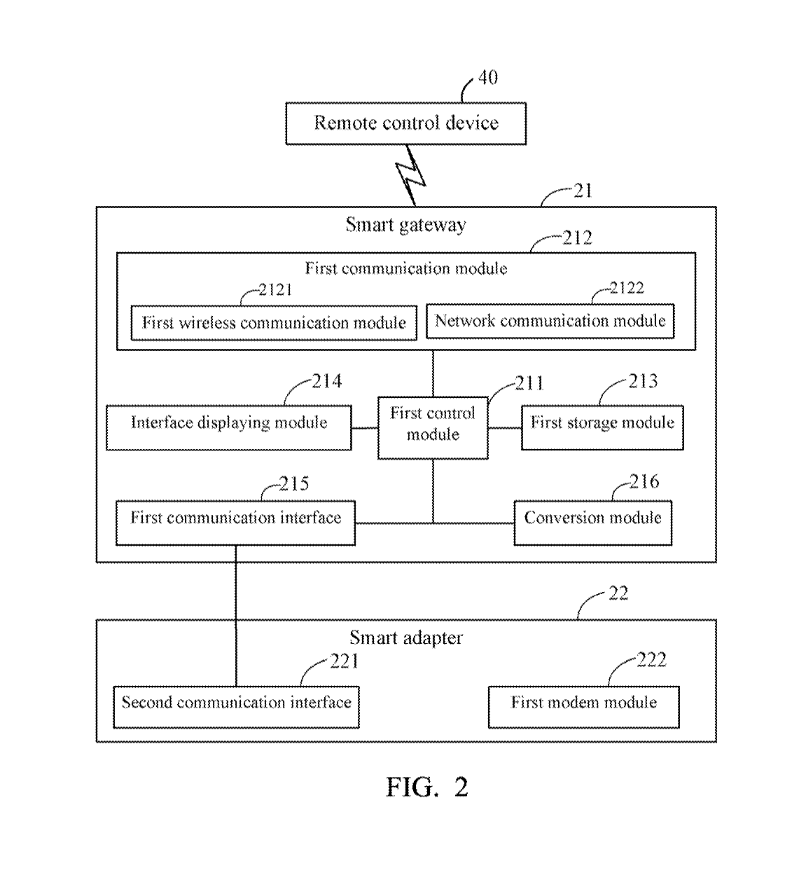

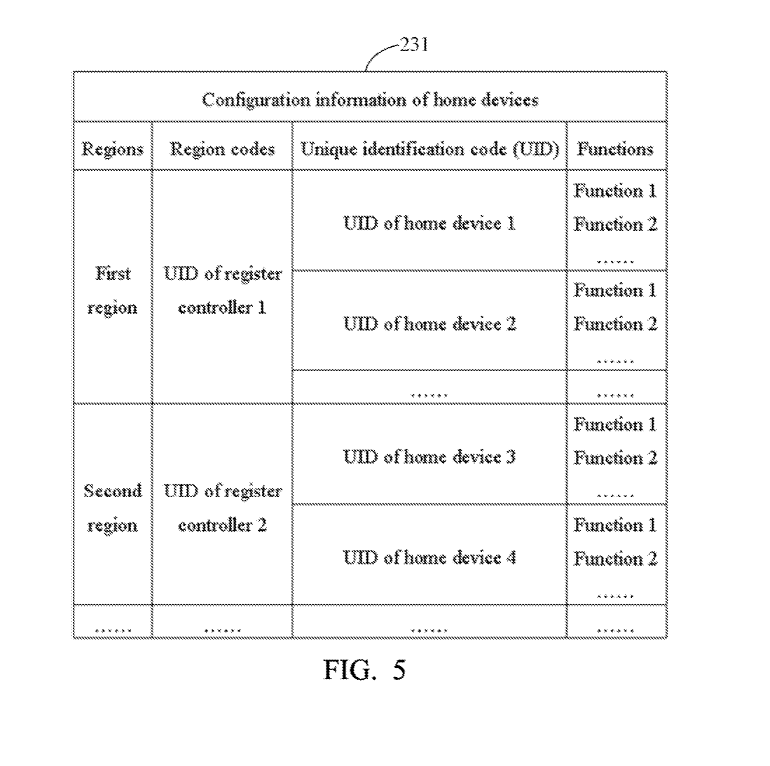

FIG. 2 shows that the smart gateway 21 includes a first control module 211, a first communication module 212, a first storage module 213, an interface displaying module 214, a first communication interface 215, and a conversion module 216. The first storage module 213 stores the UID code of the smart gateway 21 and a mapping list 231 (as shown in FIG. 5). The mapping list 231 records the configuration information of each home device 10 in the system 100. In this embodiment, the configuration information contains region codes representing areas in which the home devices 10 are placed, and the UID codes and functions of each home device 10.

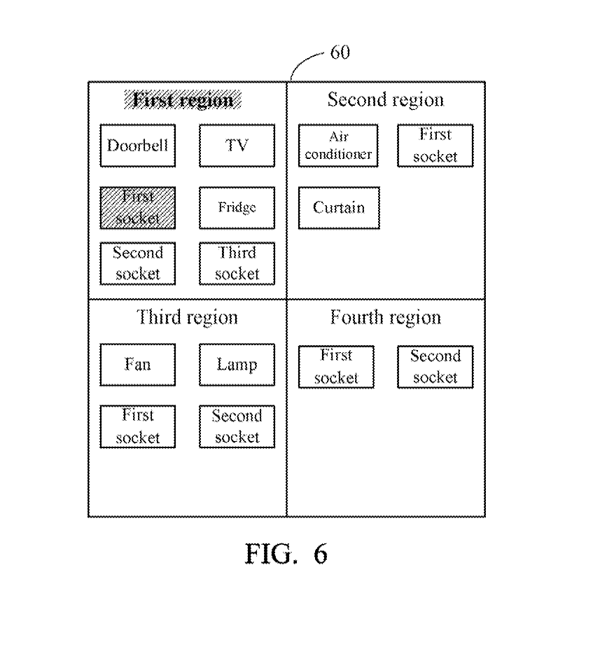

The interface displaying module 214 of the smart gateway 21 displays a control interface 60 (as shown in FIG. 6) according to the mapping list 231. In this embodiment, the control interface 60 includes a number of regions corresponding to the areas of the house. Each region includes a number of icons corresponding to the home devices 10 placed in that area of the house, and each icon is associated with a number of control options for controlling a home device 10.

In this embodiment, the remote control device 40 communicates with the smart gateway 21, and displays the control interface 60 according to the mapping list 231 stored in the smart gateway 21. Therefore, the remote control device 40 can be operated by user to generate the control information for controlling a target home device 10. The control information can be a short message or voice information, and the purpose may be to turn on or turn off a target home device, or to adjust a luminance or a temperature in the house which is controlled by the target home device.

The first communication module 212 includes a network communication module 2122, which wirelessly communicates with the remote control device 40, and receives the control information from the remote control device 40. The conversion module 216 reads the UID code of the target home device from the first storage module 213 in response to the received control information, and converts the received control information and the UID code into a control command Such that, the control command contains the UID code of the target home device. The first communication interface 215 is connected to the smart adapter 22, to allow the smart gateway 21 to transmit the control command to the smart adapter 22. In this embodiment, the first communication interface 215 is a USB socket.

The smart adapter 22 includes a second communication interface 221 and a first modem module 222. The second communication interface 221 is connected to the first communication interface 215 of the smart gateway 21, and receives the control command from the smart gateway 21. In this embodiment, the second communication interface 221 is a USB plug which plugs into the first communication interface 215 of the smart gateway 21. The first modem module 222 modulates the received control command and converts between network protocols as required, to generate an effective control signal. Then the first modem module 222 transmits the control signals to the target home device 10 via the power lines 50. In this embodiment, the control signal is a PLC signal or an OPLC signal which can be transmitted in the power lines 50.

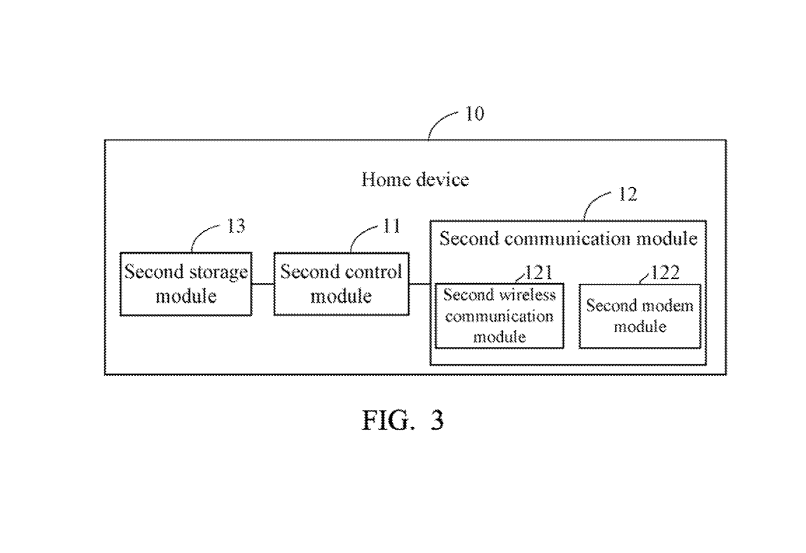

FIG. 3 shows that each home device 10 includes a second control module 11, a second communication module 12, and a second storage module 13. The second storage module 13 stores the configuration information of the home device 10.

In this embodiment, the second communication module 12 includes a second modem module 122 which is connected to the power lines 50. The second modem module 122 is configured to receive incoming control signals transmitted from the smart adapter 22 via the power lines 50, and converts between network protocols as required and demodulates the control signals. In this embodiment, although all the home devices 3 can receive the control signals, only the home device 3 having the UID code matching the UID code contained in the control signals can convert network protocols as required and demodulate the control signals. Then the second control module 11 activates the required functions in response to the control signals.

Therefore, the smart home network system 100 allows a user with the remote control device 40 in his hands to remotely control any target home device in the system 100.

In this embodiment, each home device 10 needs to register its configuration information with the smart gateway 21, when the home device 10 is first connected to the system 100 or is reconnected, to allow the smart gateway 21 to control each home device 10. In this embodiment, the system 100 further includes at least one register controller 30 (as shown in FIG. 1), each of which can be placed in a particular area (such as a living room or a kitchen) of the house. Each register controller 30 controls a number of home devices 10 in the particular area in which the register controller 30 is placed to register their respective configuration information with the smart gateway 21.

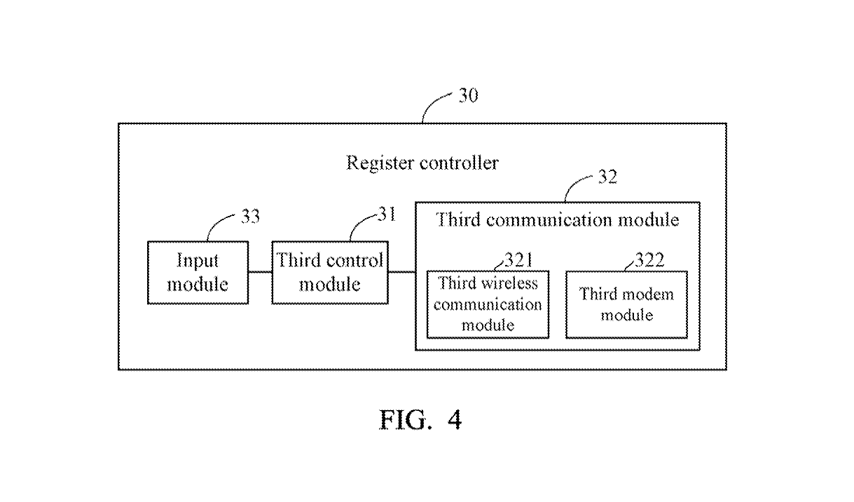

FIG. 4 shows that the register controller 30 includes a third control module 31, a third communication module 32, and an input module 33. The input module 33 is a button or a touch screen on the register controller 30 configured to allow user input.

In this embodiment, the register controller 30 is able to communicate with the home devices 10 and the smart gateway 21 via wireless communication technology. Referring again to FIGS. 2-4, in this embodiment, the first communication module 212 of the smart gateway 21 includes a first wireless communication module 2121, the second communication module 12 of the home device 10 includes a second wireless communication module 121, and the third communication module 32 of the register controller 30 includes a third wireless communication module 321. The first wireless communication module 2121, the second wireless communication module 121, and the third wireless communication module 321 can all emit and receive near field wireless signals. The near field wireless signals may include, but are not be limited to being, infrared, BLUETOOTH, Z-WAVE, NFC, ZIGBEE, and WIFI signals. In all embodiments of this present disclosure, each of the first wireless communication module 2121, the second wireless communication module 121, and the third wireless communication module 321 is an infrared signal transceiver.

The register controller 30 can also communicate with the smart gateway 21 via wired communication technology. In this embodiment, the third communication module 32 of the register controller 30 further includes a third modem module 322. The register controller 30 is connected to the smart gateway 21 via the power lines 50 and the smart adapter 22, and the first modem module 222 and the third modem module 322 can communicate with each other via PLC or OPLC technologies.

Referring again to FIG. 1, a method for registering a number of home devices 10 with the smart gateway 21 is also described, according to a first embodiment. In the first embodiment, the at least one register controller 30 includes a number of register controllers 30. Each register controller 30 is placed in a particular area in the house.

In step 1, the register controller 30 obtains the UID code of the smart gateway 21 via the third communication module 32.

In the first embodiment, the smart gateway 21 initiates a registration process, and the first control module 211 controls the first wireless communication module 2121 to send out the UID code of the smart gateway 21. The third wireless communication module 321 of the register controller 30 receives the UID code of the smart gateway 21. Because the wireless technology employed is infrared transmission, the register controller 30 must be located close to the smart gateway 21, such that the register controller 30 is within range of the infrared signal.

In step 2, the register controller 30 is brought to a first area and is connected to the system 100. The third control module 31 of the register controller 30 generates a registration request and a registration code in response to user's input in the input module 33. The third control module 31 controls the third communication module 32 to send the registration request to the smart gateway 21, and to send the registration code to all of the home devices 10 in the first area.

In the first embodiment, the third control module 31 controls the third modem module 322 to send the registration request to the smart gateway 21 via the power lines 50 and the smart adapter 22, and controls the third wireless communication module 321 to send the registration code wirelessly to all the home devices 10 placed in the first area. The registration request and the registration code contain the UID code of the smart gateway 21 and the UID code of the register controller 30.

In step 3, when the smart gateway 21 received the registration request from the register controller 30, the first control module 211 assigns a registration region and a region code in the mapping list 231 (as shown in FIG. 5) for the home devices 10 in the first area. In the first embodiment, the first control module 211 assigns the UID code of the register controller 30 that sends out the registration request as the region code for the home devices 10 in the first area, and records the region code in the registration region in the mapping list 231.

At the same time, when the home devices 10 in the first area receive the registration code from the register controller 30, the second control modules 11 control the second communication modules 12 to send their respective registration information to the smart gateway 21.

In the first embodiment, the home devices 10 receive the registration code from the register controller 30 via their second wireless communication modules 121 and send their registration information to the smart gateway 21 via their second modem modules 122 and the power lines 50. The registration information contains the UID code of the smart gateway 21, the UID code of the register controller 30, and the configuration information of the home devices 10. The configuration information contains the UID code and functions of the home devices 10.

In step 4, when the smart gateway 21 receives the registration information from the home devices 10, the first control module 211 registers the configuration information of the home devices 10 in the registration region in the mapping list 231. Therefore, the configuration information of all the home devices 10 in one area is registered in one registration region in the mapping list 231.

In the first embodiment, the smart adapter 22 receives the registration information from the home devices 10 via the first modem module 222, and transmits the registration information to the first communication interface 215 of the smart gateway 21 via its second communication interface 221.

If a new home device 10 is added to a registered area (that is, the registration information of the existing home devices in the area having already been registered in the mapping list 231 of the smart gateway 21) and it needs to be registered with the smart gateway 21, the process repeats steps 2˜4.

Since the UID code of each home device 10 is unique, the registration information of each home device 10 will only be registered once in the mapping list 231. If a home device 10 is moved to a new area, the registration information of the home device 10 registered in an original registration region in the mapping list 231 will be deleted, and the registration information of the relocated home device 10 will be registered in a new registration region in the mapping list 231.

The registration process for other home devices 10 placed in other areas is similar to that of steps 1˜4.

In step 5, the interface displaying module 214 of the smart gateway 21 displays a control interface 60 (as shown in FIG. 6), according to the mapping list 231. In the first embodiment, the control interface 60 includes a number of regions corresponding to the areas in the house. Each region includes a number of icons corresponding to the home devices 10 placed in an area in the house, and each icon includes control options corresponding to the functions of each home device 10.

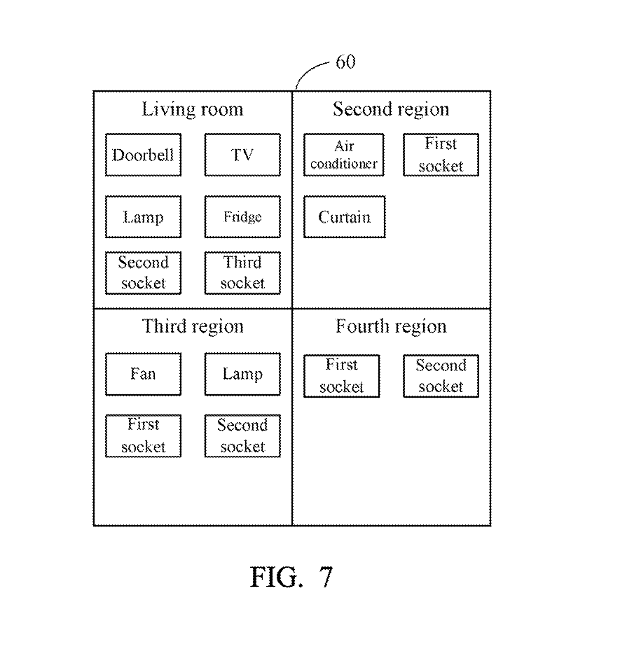

In the first embodiment, the interface displaying module 214 displays a schematic diagram of the regions according to the region codes of the mapping list 231, displays the icons of the home devices 10 in the regions according to their UID codes and the region codes registered in the mapping list 231, and displays the control options for those icons according to the registered functions. The user can rename the regions or the icons. For example, as shown in FIG. 7, the user can rename the first region as “living room” and a first socket as “lamp.”

Such that, the registration process of the home devices 10 with the smart gateway 21 in the first embodiment is completed.

In other embodiments, the above registration process further includes security processes.

In the above step 1, the smart gateway 21 further sends a password to the register controller 30. The password is used as a registration password for registering the home devices 10 with the smart gateway 21. The password can be the UID code of the smart gateway 21, for example.

In the above step 2, the register controller 30 encrypts the registration request with the password before sending the registration request to the smart gateway 21. In this embodiment, the registration code that the register controller 30 sends to the home devices 10 contains the password.

In the above step 3, the home devices 10 encrypt the registration information with the password before sending the registration information to the smart gateway 21.

When the smart gateway 21 receives the encrypted registration request from the register controller 30, or the encrypted registration information from the home devices 10, the smart gateway 21 decrypts the encrypted registration request or the encrypted registration information using the password as a key.

Therefore, the above information of the system 100 transmitted through the power lines 50 will not be obtained by devices in home network systems in other houses, in order to ensure information security.

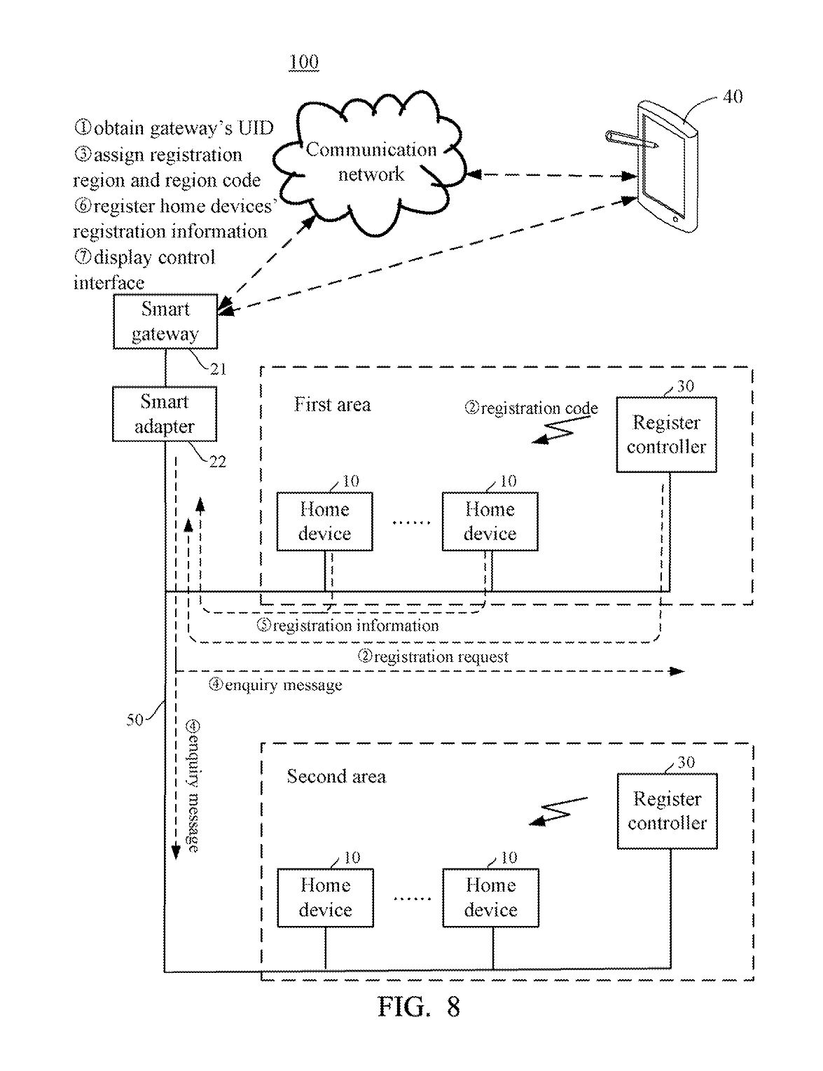

Referring to FIG. 8, a method for registering a number of home devices 10 with the smart gateway 21 is described, according to a second embodiment.

The second embodiment is similar to the first embodiment, except that after the first control module 211 assigns a registration region and a region code in the mapping list 231 for the home devices 10 (step 3), the first control module 211 generates an enquiry message that contains the region code, and the first modem module 222 of the smart adapter 22 broadcasts the enquiry message to all home devices 10 in the system 100 via the power lines 50 (step 4). The enquiry message is a signal that used to distinguish the home devices 10 which have received the registration code sent by the register controller 30, that is, to distinguish those home devices 10 which are in the same area as the register controller 30 that sent out the registration request. When the home devices 10 receive the enquiry message from the smart gateway 21 via their second modem modules 122 and have received the registration code from the registration controller 30 via their second wireless communication modules 121, the second control modules 11 of the home devices 10 determines whether or not the region code contained in the received enquiry message is the same as the UID code of the register controller 30 contained in the registration code. If the region code matches the UID code of the register controller 30, the second control modules 11 of the home devices 10 control the second modem modules 122 to send their registration information to the smart gateway 21 via the power lines 50 (step 5).

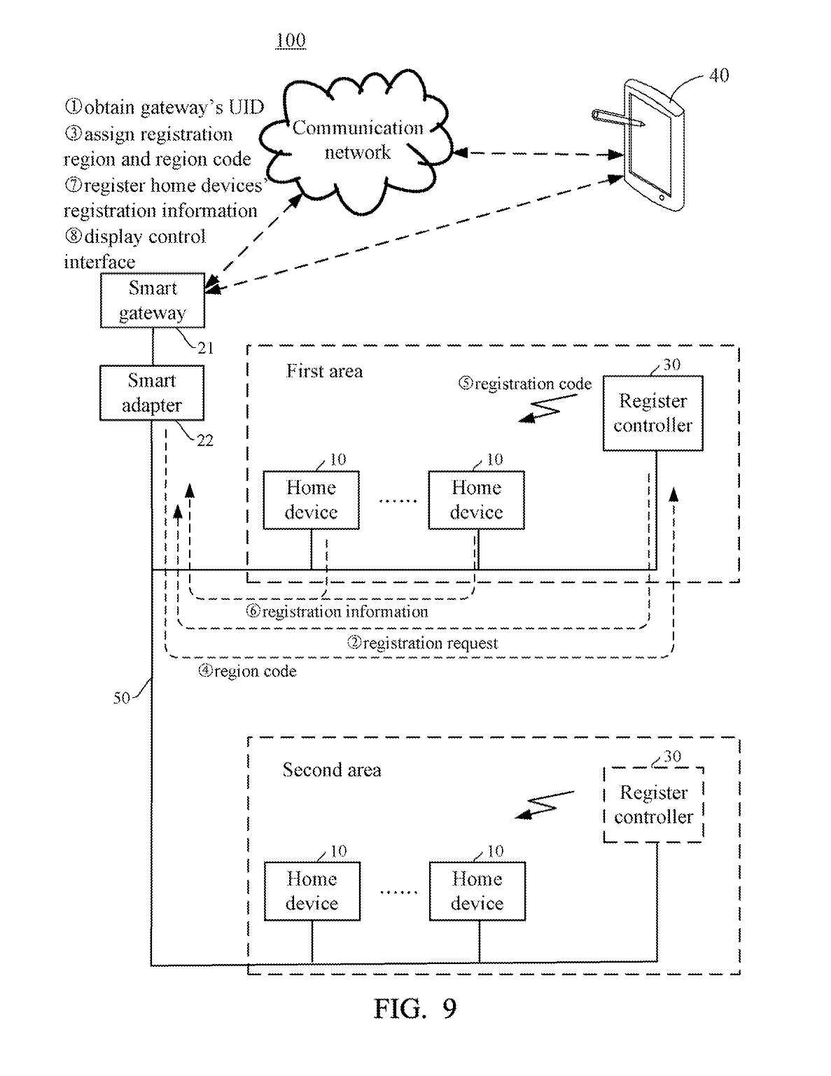

Referring to FIG. 9, a method for registering a number of home devices 10 with the smart gateway 21 is described, according to a third embodiment.

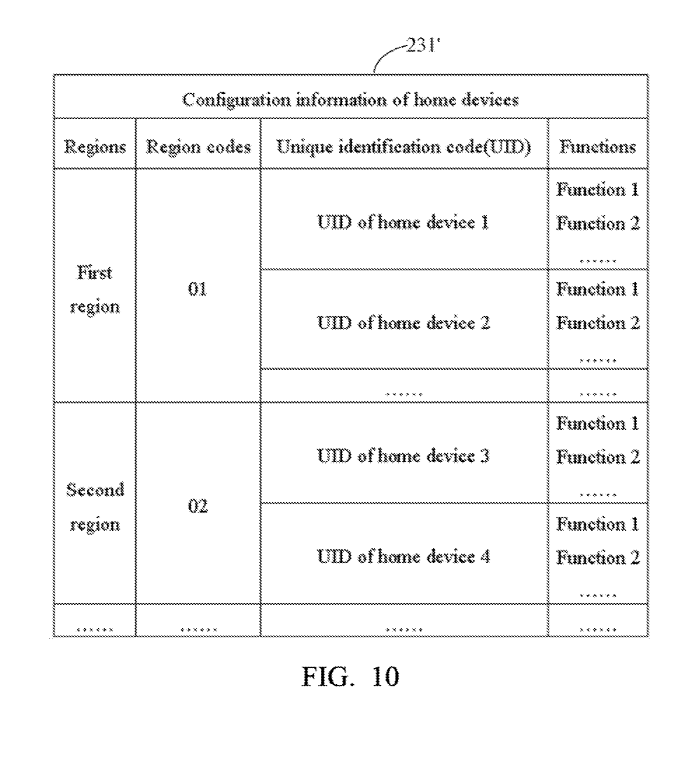

The third embodiment is similar to the first embodiment, except that the third embodiment only has one register controller 30. The register controller 30 can be moved to different areas of the house. When the user controls the register controller 30 in a first area to generate a registration request, the third modem module 322 sends the registration request to the smart gateway 21 via the power lines 50 (step 2). When the smart gateway 21 receives the registration request from the register controller 30, the first control module 211 assigns a registration region and a region code in the mapping list 231′ (as shown in FIG. 10) for the home devices 10 in the first area (step 3). In the third embodiment, the first control module 211 assigns the region code according to a numerical order, such as “001”. Then, the first modem module 222 of the smart adapter 22 sends the region code back to the register controller 30 that sends out the registration request via the power lines 50 (step 4). When the register controller 30 has received the region code via the third modem module 322, the third control module 31 generates the registration code that contains the region code and the UID code of the smart gateway 21, and the third wireless communication module 321 sends the registration code to the home devices 10 in the first area (step 5). Then the home devices 10 send their registration information to the smart gateway 21 as previously described (step 6).

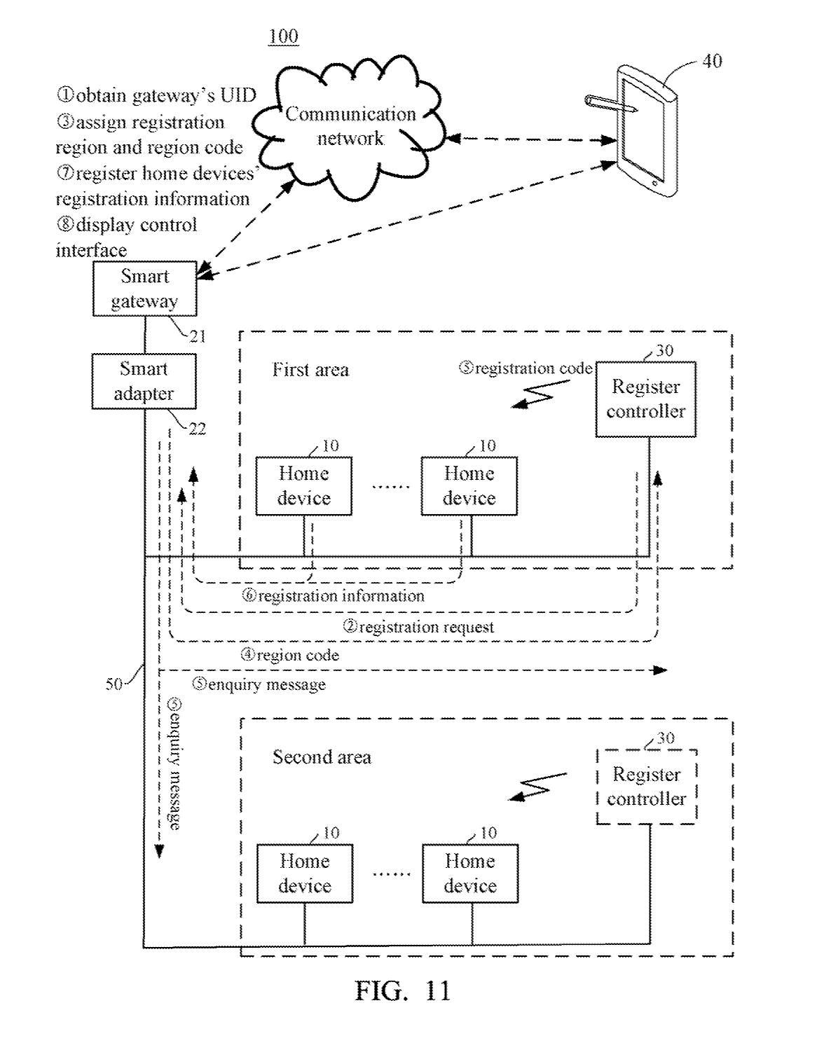

Referring to FIG. 11, a method for registering a number of home devices 10 with the smart gateway 21 is described, according to a fourth embodiment.

The fourth embodiment is similar to the third embodiment, except that the fourth embodiment utilizes an enquiry message as in the second embodiment. However, the region code is assigned according to a numerical order, such as “001”, and is not the UID code of the register controller 30. When the register controller 30 has received the region code from the smart gateway 21, the controller 30 sends the registration code to the home devices 10 in the first area (step 5). When the home devices 10 have received the enquiry message from the smart gateway 21 via the power lines 50 and have received the registration code from the registration controller 30, the home devices 10 send their registration information to the smart gateway 21 if the region code in the received enquiry message matches the region code contained in the registration code (step 6).

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart adapter applied to a smart home network system, the system comprising a plurality of home devices and a smart gateway, the smart gateway connected to the home devices via the smart adapter, the smart adapter comprising:
a communication interface connected to the smart gateway, and configured to receive a control command from the smart gateway; and
a modem module configured to modulate received control command and convert network protocols as required, to generate an effective control signal, then transmit the control signal to the target home device.

2. The smart adapter as described in claim 1, wherein the smart adapter is connected to the home devices via power lines, and the modem module of the smart adapter communicates with each home device via PLC technology or OPLC technology.

3. A smart home network system comprising a plurality of home devices, a smart gateway and a smart adapter,
the smart gateway connected to the home devices via the smart adapter, the smart adapter comprising a first communication interface; and
the smart adapter comprising:
a second communication interface connected to the first communication interface of the smart gateway, and configured to receive a control command from the smart gateway; and
a first modem module configured to modulate received control command and convert network protocols as required, to generate an effective control signal, then transmit the control signal to the target home device.

4. The system as described in claim 3, wherein the smart gateway further comprises:
a first storage module configured to store a mapping list, wherein the mapping list records the configuration information of each home device in the system, and the configuration information contains UID codes of each home device;
a network communication module communicating with a remote control device, and receiving control information from the remote control device;
a conversion module configured to read the UID code of the target home device from the first storage module in response to the received control information, and convert the received control information and the UID code into the control command; and
a first control module configured to control the first communication module to transmit the control command to the smart adapter.

5. The system as described in claim 4, wherein each home device comprises:
a second modem module configured to receive incoming control signal transmitted from the smart adapter, and converts between network protocols as required and demodulate the control signal; and
a second control module configured to activate a required function in response to the control signal.

6. The system as described in claim 4, further comprising the remote control device, the remote control device configured to generate and send the control information for controlling the target home device to the smart gateway, wherein the control information is selected from a group consisting of a short message, and voice information.

7. The system as described in claim 4, wherein the smart gateway further comprises an interface displaying module configured to display a control interface according to the mapping list.

8. The system as described in claim 3, wherein the first communication interface is a USB socket, and the second communication interface is a USB plug which plugs into the first communication interface of the smart gateway.

9. The system as described in claim 5, further comprising at least one register controller connected to the smart gateway, wherein each register controller comprises:
an input module and a third control module, the third control module configured to generate registration request in response to user's input in the input module;
a communication module configured to obtain the UID of the smart gateway and a region code assigned by the smart gateway, and send the registration request to the smart gateway, wherein the third control module further generate a registration code that contains the region code and the UID code of the smart gateway, and the communication module sends the registration code to all of the home devices in the area in which the register controller is placed.

10. The system as described in claim 9, wherein the first storage module of the smart gateway further stored the UID code of the smart gateway, the smart gateway further comprises a first wireless communication module, the home device further comprises a second wireless communication module, the communication module of the register controller comprises a third wireless communication module, and wherein the third wireless communication module communicates with the first wireless communication module to obtain the UID code of the smart gateway, and the third wireless communication module communicates with the second wireless communication module to send the registration code to the home devices.

11. The system as described in claim 9, wherein the communication module of the register controller comprises a third modem module, which communicates with the first modem module to send the registration request to the smart gateway via the smart adapter.

12. The system as described in claim 11, wherein when the smart gateway received the registration request from the register controller, the first control module assigns a registration region and a region code in the mapping list for the home devices in the area in which the register controller is placed, and the first modem module of the smart adapter sends the region code back to the register controller that sends out the registration request.

13. The system as described in claim 12, wherein the smart gateway is connected to each home device and the register controller via the smart adapter and power lines, and the first modem module communicates with the second modem module of each home device and the third modem module of the register controller via PLC or OPLC technologies.

14. The system as described in claim 9, wherein the home device further comprises a second storage module configured for storing the configuration information of the home device, when the home device receives the registration code from the register controller, the second control module controls the second modem module to send the registration information of the home device to the smart gateway.

15. The system as described in claim 14, wherein when the first communication module of the smart gateway received the registration information from the home devices, the first control module registers the configuration information of the home devices in the corresponding registration region in the mapping list.
